(19) United States
(12) Patent Application Publication
(10) Pub. No.: US 2014/0038523 A1
(43) Pub. Date: Feb. 6, 2014

(54) HIERARCHICAL NAVIGATION AND REMEDIATION IN DATACENTERS

(71) Applicants: Patrick C. McGeer, Orinda, CA (US); Dejan S. Milojicic, Palo Alto, CA (US)

(72) Inventors: Patrick C. McGeer, Orinda, CA (US); Dejan S. Milojicic, Palo Alto, CA (US)

(21) Appl. No.: 13/562,569

(22) Filed: Jul. 31, 2012

(51) Int. Cl. H04B 7/00

(52) U.S. Cl. 455/41.2

(57) ABSTRACT

Methods, devices, and machine-readable and executable instructions are provided for hierarchical navigation and remediation in datacenters. An example method to provide hierarchical navigation and remediation confirmation in datacenters includes providing navigation toward a reported component with a mobile electronic device via a hierarchy of navigational functionality that includes a differential wireless signal positioning system and a short range beacon detection system, verifying an identity of the reported component with the mobile electronic device, providing a testing protocol with the mobile electronic device to diagnose a fault associated with the reported component, providing a number of remedial instructions regarding the reported component with the mobile electronic device, and providing a remediation verification protocol with the mobile device to confirm whether the remediation was successful.

### BACKGROUND

A datacenter may refer to computational resources related to data storage. The datacenter may include computer networking components to connect portions of the datacenter. The datacenter may include environmental controls (e.g., air conditioning and/or fire suppression) and/or security devices related to access to the datacenter or the computational resources.

### BRIEF DESCRIPTION OF THE DRAWINGS

FIG. 1 illustrates a block diagram of an example method to provide hierarchical navigation and remediation confirmation in datacenters according to the present disclosure.

FIG. 2 is a block diagram illustrating an example of a computing device to provide hierarchical navigation and remediation in datacenters according to the present disclosure.

FIG. 3 is a block diagram of an example of a mobile electronic device for hierarchical navigation and remediation confirmation in datacenters according to the present disclosure.

### DETAILED DESCRIPTION

With increasing pressure to improve performance, organizations may seek to increase efficiency associated with data storage and/or computational resources, for instance, by pursuing a decrease in costs involved with repair of datacenters. Datacenters can include a plurality of components (e.g., resources), for example, computational resources related to data storage, computer networking components (e.g., to connect portions of the datacenter), environmental control components (e.g., air conditioning, fire suppression), and security components (e.g., for controlling access to the datacenter and/or the computational resources), among others.

Each of the plurality of components can, on occasion, fail to perform one or more of the intended functions of the component. Such a failure, can lead to failures of one or more related components of the plurality of components and/or negatively impact operation (e.g., decrease available storage for data) of the datacenter. In order to enable efficient operation of the datacenter and/or the plurality of components in the datacenter the non-functional component can be remediated (e.g., repaired and/or replaced).

Costs of remediation of the plurality of components can include training field engineers (e.g., monetary compensation of field engineers during a training period and/or training materials), remediation components, and/or tools (e.g., physical equipment and/or software) for replacement and/or repair of the plurality of components, among others. Examples of remediation components can include redundant components (e.g., offline backup components), replacement components, and/or replacement parts for the plurality of components, among others.

Additionally, the remediation costs can include a cost (e.g., time) associated with locating a component in need of remediation in a datacenter. Datacenters can include a number of buildings that house the plurality of components of the datacenter. The datacenter can include facilities (e.g., office space) for staff (e.g., Information technology (IT) administrators) that can be responsible for the performance and/or maintenance of the datacenter. Cost (e.g., an amount of time to navigate to a reported component) can be a function of the size, total number, and/or complexity (e.g., layout of the number of buildings) of the number of buildings, among others. For example, a datacenter can include a thousand servers located in a number of buildings (e.g. 10 buildings). Hence, the number of buildings of the datacenter can define a volume of space for housing such a number of servers and supporting infrastructure (e.g., office space, the environmental components, security components, and/or networking components, among others).

Further, the remediation costs can include no faults found (e.g., no faults found repair). As described herein, no faults found can occur when an unnecessary (e.g., excess) amount of time and/or replacement components and/or parts are allocated to one of the plurality of components of the datacenter. For instance, a type of remediation required can be incorrectly identified and/or performed. For example, the replacement of a reported component (e.g., a first component) with a second component can appear to have remedied a fault. However, the fault could have been remedied by a comparatively less expensive remediation (e.g., updating firmware associated with the first component rather than remediation costs associated with replacing the first component). Hence, the increased time (e.g., time to replace and/or initialize the second component compared to a time to update the firmware of the first component) can be unnecessary.

Moreover, even in the instance of a properly performed remediation (e.g., performing the comparatively least expensive remediation to remedy a fault), one of the plurality of components (e.g., a third component) can be misidentified as being in need of remediation. For example, a fault can be reported in a fourth component. That is, the third component can be functioning properly while the fourth component (e.g., in proximity to the third component) can be reported for remediation. If the third component is incorrectly identified as the reported component (e.g., the fourth component), upon remediation, (e.g., replacing the third component) the fault can persist. Hence, resources (e.g., time and/or replacement components) have been allocated to remediate the third component but have not fixed the fault corresponding to the fourth component.

Such incorrect identification of the type of remediation needed (e.g., no faults found) and/or misidentification of the component in need of remediation can lead to increased cost (e.g., unnecessary time and/or replacement components) associated with remediating the fault. In contrast, examples of the present disclosure can provide hierarchical navigation to a component in need of remediation, which can enable efficient (e.g., a reduction in the amount of time) location, remediation, and/or remediation confirmation relating to one of the plurality of components in need of remediation.

Examples of the present disclosure include methods, devices, and machine-readable and executable instructions to provide hierarchical navigation, remediation, and/or remediation confirmation. An example of a method to provide hierarchical navigation and remediation confirmation includes providing navigation toward a reported component with a mobile electronic device via a hierarchy of navigational functionality that includes a differential wireless signal positioning system and a short range beacon detection system, verifying an identity of the reported component with the mobile electronic device, providing a testing protocol with the mobile electronic device to diagnose a fault associated with the reported component, providing a number of remedial instructions regarding remediation of the reported component with the mobile electronic device, and providing a remediation verification protocol with the mobile device to confirm whether the remediation was successful.

Faults (e.g., involving the reported component) can be reported to a backend datacenter by a number of sources. The backend datacenter can include computational resources (e.g., related to management of the datacenter), computer networking components (e.g., to connect to portions of the datacenter), and/or support personal (e.g., IT administrators and/or field engineers), and/or storage (e.g., a number of databases), among others. Alternatively or in addition, the backend datacenter can enable storage of remediation components (e.g., replacement parts). The backend datacenter can transmit, receive, and/or store data relating to the plurality of components in the datacenter. The backend datacenter can be substantially at a location of the datacenter (e.g., included in the datacenter) or can be at a location remote to the location of the datacenter.

Examples of the number of sources include customers (e.g., those utilizing storage at a datacenter), support personnel (e.g., the field engineers), and/or periodic functionality checks (e.g., testing the plurality of components to ensure intended functionality), among others. For example, a customer can report one of the plurality of components in the datacenter by an identifier, as described herein, associated with the component and/or by a location of the component.

In some examples, periodic functionality checks can be scheduled (e.g., by an information technology (IT) administrator) to check a number of functions of the plurality of components. The periodic functionality checks can be scheduled on a weekly, monthly, or some other basis (e.g., by an IT administrator).

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

As will be appreciated, elements shown in the various examples herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein, “a number of” an element and/or feature can refer to one or more of such elements and/or features. In addition, “for example” and similar phrasing is intended to mean, “by way of example and not by way of limitation”

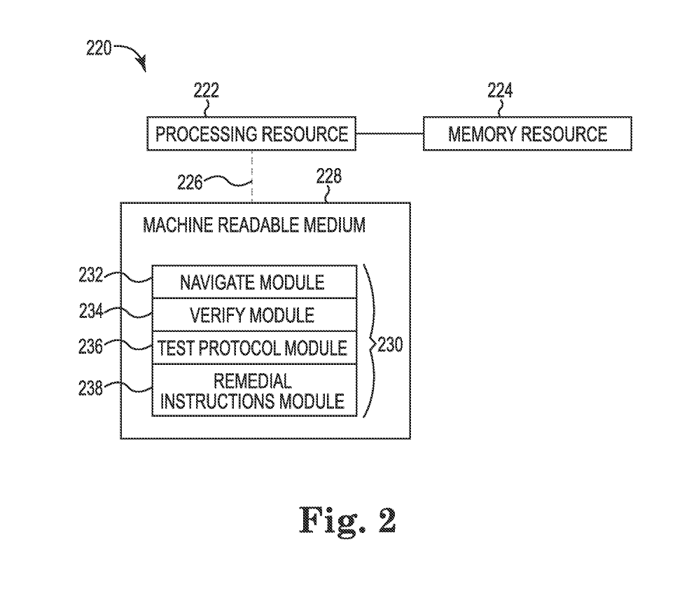

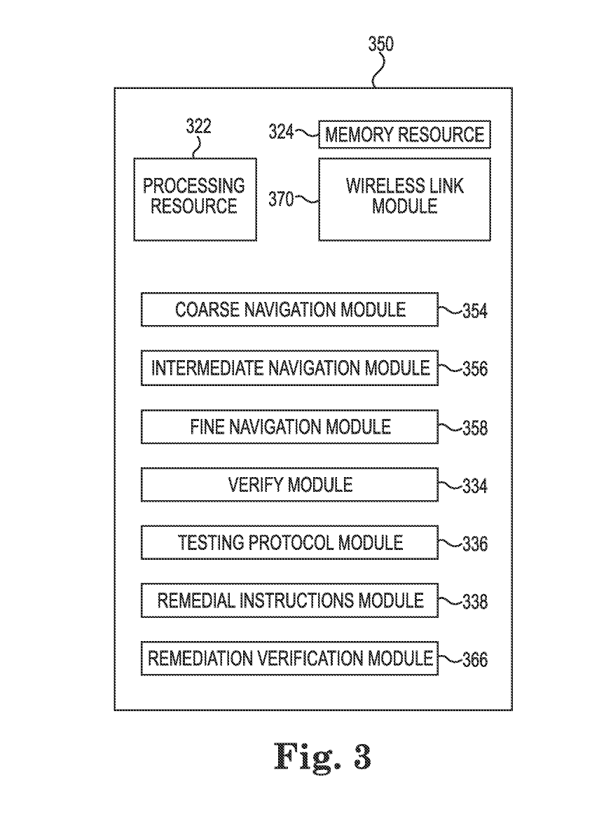

The figures herein follow a numbering convention in which the first digit or digits correspond to the drawing figure number and the remaining digits identify an element or component in the drawing. Similar elements or components between different figures may be identified by the use of similar digits. For example, 212 may reference element “12” in FIG. 2, and a similar element may be referenced as 312 in FIG. 3. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

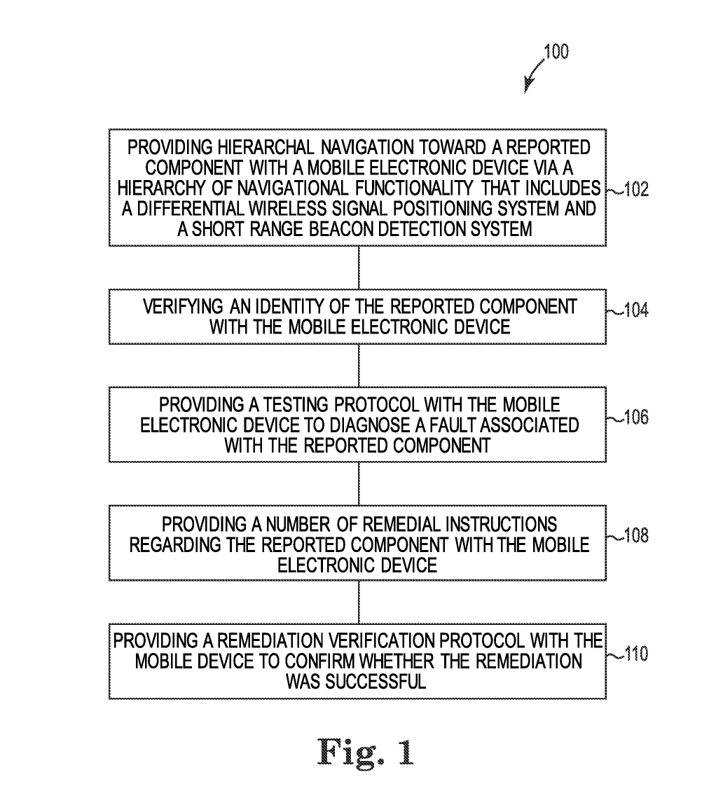

FIG. 1 illustrates a block diagram of an example method 100 to provide navigation and remediation confirmation according to the present disclosure. As shown at block 102, in various examples, the method can include providing hierarchical navigation toward a reported component with a mobile electronic device via a hierarchy of navigational functionality that can include a differential wireless signal positioning system and/or a short range beacon detection system.

As described herein, a mobile electronic device can be an electronic device for providing hierarchical navigation, remediation, and/or remediation confirmation, as described herein. Examples of mobile electronic devices include cell phones, laptop computers, and/or computer tablets, among other portable electronic devices capable of providing hierarchical navigation, remediation, and/or remediation confirmation, as described herein. The mobile electronic device can be connected in a wired and/or wireless manner to a backend datacenter, as described herein.

The mobile electronic device can include a number of hardware and/or software components (e.g., optical recognition software) in accordance with the present disclosure. Examples of the number of hardware components include a visual identification device, as described herein, and/or keyboard, among others. The mobile electronic device can include a number of input and/or output devices in accordance with the present disclosure. Examples of output devices include audio generating devices (e.g., speakers), visual displays (e.g., user interface), and/or haptic output devices, among others.

In some examples, the mobile electronic device can facilitate wired communication with the backend datacenter. For example, the mobile electronic device can include an output (e.g., a port) to enable a communication cable to be connected (e.g., inserted into the port) such that a second end of the communication cable can be connected to one of the plurality of components to enable communication via the component with the backend datacenter (e.g., enabling communication via the component with the backend datacenter).

In some examples, the hierarchy of navigational functionality can include providing coarse navigation toward the reported component. For example, a global positioning system (GPS) (e.g., in the form of a GPS receiver and associated software to provide directional navigation based at least in part on GPS signals received from satellites). Another example of coarse navigation can include navigation based on signals received from cellular towers (e.g., either alone and/or in combination with the received GPS signals).

In some examples, providing navigation can include providing intermediate navigation toward the reported component via the differential wireless signal positioning system. In some examples, the differential wireless signal positioning system can comply with a 802.011x standard. In some examples, providing navigation can include providing fine navigation toward the reported component via the short range beacon detection system. In some examples, the short range beacon detection system can comply with a Bluetooth standard and/or Radio-frequency identification (RFID) standard.

As described herein, hierarchical navigation is incrementally precise navigation provided via a hierarchy of navigational functionality. The navigation functionality can be provided by any suitable electronic technology capable of producing a signal associated with navigation. That is, a combination (e.g., two or more) of the suitable electronic devices can facilitate hierarchical navigation

The hierarchical navigation can employ a number of markers (e.g., beacons) in and/or around the datacenter. The number of markers can enable hierarchical navigation (e.g., denote location(s), at which, it can be advantageous to change to a comparatively more precise technology) and/or identify a location of one of the plurality of components in the datacenter. Examples of the number of markers can include visual markers (e.g., signs) and/or electronic markers (e.g., predetermined locations for use with GPS), among others.

For example, the coarse navigation can be provided by a GPS toward (e.g., while outside) the building housing the reported component. A first marker can be positioned (e.g., near an entrance to the building) to indicate (e.g., automatically via the mobile device) that a comparatively more precise navigation functionality (e.g., intermediate navigation) can be properly employed. The intermediate navigation can be provided by a differential wireless positioning system to navigate to an approximate location of a reported component, for example, as indicated by a second marker indicating (e.g., automatically via the mobile device) that a comparatively more precise navigation can properly be employed (e.g., fine navigation). The fine navigation can be provided by a short range beacon detection system (e.g., RFID) to a location of the reported component. Hence, the number of markers can promote hierarchical navigation (e.g., a hierarchy of navigation functionality including incrementally precise systems) thereby facilitating efficient (e.g., minimizing time) navigation to a particular location associated with one of the plurality of components in the datacenter in accordance with the methods described herein.

As shown at block 104, in various examples, the method can include verifying an identity of the reported component with the mobile electronic device. In some examples, verifying the identity of the reported component can include optically capturing an identifier associated with the reported component via a visual identification device. Examples of visual identification devices can include a quick response code (QR) reader, a barcode reader, an optical capture device (e.g., a camera), and/or other suitable optical recognition technology (e.g., optical recognition software), among others. An optical capture device can capture pictures and/or videos (e.g., of the reported component).

As described herein, the identifier can be a barcode, a QR code, and/or another optically identifiable characteristic (e.g., the physical shape of all and/or a portion of the reported component). Hence, the identifier can be separate or integral with the plurality of components. In addition, the identifier can include a human-readable identifier (e.g., a label in a human-readable format) associated with the plurality of components (e.g., the reported component).

The identifier can be at and/or substantially at the location of the reported component. For example, an identifier can be located on a portion (e.g., an externally visible portion) of each of the plurality of components. This can enable optically capturing the identifier (e.g., associated with the reported component) via a visual identification device, as described herein.

A QR reader can read (e.g., by optically scanning) a QR code that can encode information via a number of black square dots arranged in a square pattern on a white background. For example, the encoded information can be one of more modes of numeric, alphanumeric, byte (e.g., binary), and/or Kanji data that can enable hierarchical navigation and/or remediation confirmation.

A barcode reader can read (e.g., by optically scanning) a barcode (e.g., Universal Product Code (UPC)) that can consist of numerical digits (e.g., 12 digits), which are uniquely assigned to an item (e.g., one of the plurality of components). Examples of the barcode symbology include UPC-A, global trade item number (GTIN)-12 number encoded in UPC-A, international article number (EAN)-8, and/or UPC-E, among others.

As shown at block 106, in various examples, the method can include providing a testing protocol with the mobile electronic device to diagnose a fault associated with the reported component. As described herein, a testing protocol can include instructions to test the reported component. The testing protocol can be specific to the reported component and/or to a nature of a reported fault. The instructions can be provided via visual, audio, and/or haptic output functionality of the mobile electronic device, as described herein.

The testing protocol can identify and/or verify a fault with the reported component. In some examples, the testing protocol can enable reproduction of the fault (e.g., a reported fault). The testing protocol can employ a number of strategies (e.g., different approaches) for reproduction of the fault.

As shown at block 108, in various examples, the method can include providing a number of remedial instructions regarding the reported component with the mobile electronic device. In some examples, the remedial instructions can be instructions to repair the reported component. In some examples, the remedial instructions can be instructions to replace the reported component.

The remedial instructions can be based on transmitted (e.g., wirelessly) results of the testing protocol. The remedial instructions can be received (e.g., wirelessly) based on the transmitted results (e.g., results of the test protocol). The remedial instructions can be provided via visual, audio, and/or haptic output functionality of the mobile electronic device, as described herein. The remedial instructions can be specific to the reported component, a fault reported, and/or a fault identified (e.g., as described at block 102).

Replacement can include removal of the reported component and/or initializing an equivalent component (e.g., a redundant backup of the reported component). Replacement and/or repair, with or without removal of the component, can include placing a number of components (e.g., a sequence of components) offline. For instance, before, during, and/or after replacement and/or repair of the reported component. For example, a power supply to the reported component can be placed offline before repair (e.g., removal) of the reported component. Hence, the remedial instructions can include directions to a number of preliminary component(s) (e.g., the power supply) that require action to be taken before repairing the reported component.

As shown at block 110, in various examples, the method can include providing a remediation verification protocol with the mobile device to confirm whether the remediation was successful. For example, the remediation verification protocol can include instructions to bring the reported component on-line (e.g., into normal operating mode) following remediation and/or testing to ensure proper on-line functionality.

In some examples, the remediation verification protocol can include receiving the remediation verification protocol and/or displaying the remediation verification protocol in a human-readable format. In some examples, providing the remediation verification protocol can include transmitting an outcome (e.g., indicating whether the remediation verification protocol was successful), as described herein, to the backend datacenter.

FIG. 2 is a block diagram illustrating an example of a computing device 220 to provide hierarchical navigation and remediation in datacenters according to the present disclosure. The computing device 220 can utilize software, hardware, firmware, and/or logic to provide hierarchical navigation and remediation, and/or remediation confirmation in datacenters. The computing device 220 can perform the functions of the method, for example, those described in FIG. 1.

The computing device 220 can be any combination of hardware and program instructions to select a desired data path. The hardware, for example can include a number of processing resources (e.g., the processing resource 222), machine readable medium (MRM) 228 (e.g., MRM, database, etc.). The program instructions (e.g., machine-readable instructions (MRI) 230) can include instructions stored on the MRM 228 and executable by the processing resource 222 to implement a desired function (e.g., provide hierarchical navigation, etc.).

The processing resource 222 can be in communication with a tangible non-transitory MRM 228 storing a set of MRI 230 executable by the number of processing resources (e.g., 222), as described herein. The MRI 230 can also be stored in remote memory managed by a server and represent an installation package that can be downloaded, installed, and executed. The computing device 220 can include a memory resource 224, and the processing resource 222 can be coupled to the memory resource 224.

The processing resource 222 can execute MRI 230 that can be stored on an internal and/or external non-transitory MRM 228. The processing resource 222 can execute MRI 230 to perform various functions, including the functions described herein. For example, the processing resource 222 can execute MRI 230 to provide navigation toward a reported component via a hierarchy of navigational functionality.

The MRI 230 can include a number of modules 232, 234, 236, 238. The modules 232, 234, 236, 238 when executed by the processing resource 222 can perform a number of functions. The 232, 234, 236, 238 can be and/or can include sub-modules of other modules. For example, a test protocol module 236 and a remedial instructions module 238 can be sub-modules of and/or contained within a same module (not illustrated). In another example, modules 232, 234, 236, 238 can include individual modules on separate and distinct computing devices.

A navigate module 232 can include MRI 230 that when executed by the processing resource 222 can perform a number of functions (e.g., provide navigation toward a reported component via a hierarchy of navigational functionality, etc.). The navigate module 232 can, in various examples, provide navigation toward a reported component via a hierarchy of navigational functionality that can include a global positioning system, a differential wireless signal positioning system, and/or a short range beacon detection system, as described herein.

A verify module 234 can include MRI 230 that when executed by the processing resource 222 can perform a number of functions (e.g., verify an identity of the reported component, etc.). The verify module 234 can, in various examples, verify an identity of the reported component substantially at the location of the reported component with the mobile electronic device, as described herein.

A test protocol module 236 can include MRI 230 that when executed by the processing resource 222 can perform a number of functions (e.g., provide a test protocol). In various examples, the test protocol module 236 can provide a test protocol to diagnose a fault associated with the reported component. The test protocol can include any suitable protocol to diagnose a fault. Additionally, in various examples, the test protocol module 236 can transmit results of the test protocol to a database (e.g., located in the backend datacenter) from the computing device 220 and/or receive a number of remedial instructions from the database based on the results of the test protocol. The results and/or the number of remedial instructions can be transmitted in a wired and/or wireless manner, as described herein.

A remedial instructions module 238 can include MRI 230 that when executed by the processing resource 222 can perform a number of functions. In various examples, the remedial instructions module 238 can provide a number of remedial instructions, as described herein, regarding remediation of the reported component. In some examples, the remedial instructions module can receive (e.g., wirelessly) the number of remedial instructions, and/or can display the number of remedial instructions in a human-readable format. For example, by displaying the number of remedial instruction via a graphical user interface (not shown) coupled to the processing resource 222.

The graphical user interface can include user interface options (e.g., drop-boxes, menus, selectable tiles, among others) that can enable a user to interact with the mobile electronic device to enable hierarchical navigation, remediation, and/or remediation confirmation, as described herein. In some examples, the graphical user interface can display testing protocol, remedial instructions, and/or remediation verification protocol, among others, in a human-readable format.

A non-transitory MRM 228, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of machine-readable media.

The non-transitory MRM 228 can be integral and/or communicatively coupled (e.g., in a wired and/or a wireless manner), to a computing device. For example, the non-transitory MRM 228 can be an internal memory, a portable memory, a portable disk, or a memory associated with another computing resource (e.g., enabling MRIs to be transferred and/or executed across a network such as the Internet).

The MRM 228 can be in communication with the processing resource 222 via a communication path 226. The communication path 226 can be local or remote to a machine (e.g., a computer) associated with the processing resource 222. Examples of a local communication path 226 can include an electronic bus internal to a machine (e.g., a computer) where the MRM 228 is one of volatile, non-volatile, fixed, and/or removable storage medium in communication with the processing resource 222 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 226 can be such that the MRM 228 is remote from the number of processing resources (e.g., the processing resource 222), such as in a network connection between the MRM 228 and the processing resource 222. That is, the communication path 226 can be a network connection. Examples of such a network connection can include a local area network (LAN), wide area network (WAN), personal area network (PAN), and the Internet, among others. In such examples, the MRM 228 can be associated with a first computing device and the processing resource 222 can be associated with a second computing device (e.g., a Java® server). For example, a processing resource 222 can be in communication with a MRM 228, the MRM 228 including a set of instructions, and the processing resource 222 can be designed to carry out the set of instructions.

As used herein, “logic” is an alternative or additional processing resource to execute the actions and/or functions, etc., described herein, which includes hardware (e.g., various forms of transistor logic, application specific integrated circuits (ASICs), etc.), as opposed to machine executable instructions (e.g., software, firmware, etc.) stored in memory and executable by a processor. As used herein, “a” or “a number of” something can refer to one or more such things.

FIG. 3 is a block diagram of an example of a mobile electronic device for hierarchical navigation and remediation confirmation according to the present disclosure. As illustrated in FIG. 3, the mobile electronic device 350 can include a processing resource 322. The processing resource can, for example, be analogous to the processing resource 222 described in FIG. 2.

The mobile electronic device 350 can include hardware (e.g., electronic circuits such as ASICS) and/or software providing analogous functionality to that described with respect to MRM 230 in FIG. 2. The mobile electronic device 350 can include a number of modules 334, 336, 338, 354, 356, 358, 366. The modules 334, 336, 338, 354, 356, 358, 366 can be sub modules. For example, a course navigation module 354 and a verify module 334 can be sub-modules and/or contained within the same mobile electronic device 350. Additionally, in some examples, modules 334, 336, 338, 354, 356, 358, 366 can be sub-modules of other modules.

The modules 334, 336, 338, 354, 356, 358, 366 can include MRI (e.g., 230) that can be executed, for example, by the processing resource (e.g., 222) to perform a number of functions, as described herein. In some examples, all or a portion of the modules can be executed automatically by the processing resource 322 to automatically perform the number of functions, as described herein.

The mobile electronic device 350 can, in various examples, provide navigation toward a location of a reported component via a hierarchy of navigational functionality that includes a GPS, differential wireless signal positioning system, and/or a short range beacon detection system. In some examples, the mobile electronic device 350 can include a number of sub modules including a coarse navigate module 354, an intermediate navigation module 356, and/or a fine navigation module 358.

In some examples, the coarse navigation module 354 can provide coarse navigation toward the reported component via the GPS and/or the intermediate navigation module 356 can provide intermediate navigation toward the reported component via the differential wireless signal positioning system. In some examples, the differential wireless signal positioning system can comply with an 802.11x standard.

In some examples, the fine navigation module 358 can provide fine navigation toward the reported component via the short range beacon detection system. In some examples, the short range beacon detection system can comply with a Bluetooth standard and/or a Radio-frequency identification standard. That is, providing navigation can include any suitable number and/or combination of technologies (e.g., the number of modules 334, 336, 338, 354, 356, 358, 366) to enable the hierarchy of navigational functionality for hierarchical navigation to a location of a reported component.

A verify module 334 can, in various examples, verify an identity of the reported component by optically capturing an identifier associated with the reported component via a visual identification device. In various examples, the visual identification device can include a quick response code reader and/or a barcode reader. The verify module 334 can be in communication with a wireless link module 370, as described herein, to enable the verification module to receive and/or transmit data associated with the reported component. For example, the verify module 334 can, in some examples, receive data (e.g., the identifier) to enable verification of the reported component.

A testing protocol module 336 can, in various examples, receive a testing protocol to diagnose a fault associated with the reported component. In various examples, the testing protocol module can transmit results of the testing protocol. That is, the testing protocol module 336 can be in communication with a wireless link module 370, as described herein, to enable the testing protocol module 336 to receive and/or transmit data associated with the reported component. For example, the testing protocol module 336 can, in some examples, receive data (e.g., an identifier) to enable verification of the reported component.

A remedial instruction module 338 can, in various examples, receive a number of remedial instructions and/or provide the number of remedial instructions regarding remediation of the reported component (e.g., within a datacenter) with the mobile electronic device. A remediation verification module 366 can, in various examples, receive a verification protocol to confirm whether the remediation was successful. In some examples, the remediation verification module 366 can transmit a confirmation whether the remediation was successful. In some examples, the confirmation can include an output (e.g., yes or no). In some examples, the remediation verification module 366 can receive a set of instructions to reinitiate the testing protocol (e.g., by communicating with the testing protocol module 336) when the output is no.

A wireless link module 370 can, in various examples, wirelessly transmit data relating to the testing protocol module, the remedial instructions module, and/or the remediation verification module, among others. The wireless link module 370 can be in communication via a communication path (e.g., 226) with the modules 334, 336, 338, 354, 356, 358, and 366 of the mobile electronic device 350. The wireless link module can communicate with other components in the datacenter (e.g., wirelessly) and/or with the backend datacenter, as described herein. That is, in some examples, the wireless link module 370 can transmit data that can include the identifier regarding the reported component, a location of the reported component, a result of the testing protocol, and/or an outcome of the verification protocol, among others.

The mobile electronic device 350 can include a memory resource 324. The memory resource can include volatile and/or non-volatile memory, as described herein. The memory resource can store data regarding the functions of the modules 334, 336, 338, 354, 356, 358, and 366 and/or the plurality of components in the datacenter.

The specification examples provide a description of the applications and use of the method of the present disclosure. Since many examples can be made without departing from the spirit and scope of the method of the present disclosure, this specification sets forth some of the many possible example configurations and implementations.

What is claimed:

1. A method to provide hierarchical navigation and remediation confirmation in datacenters, the method comprising:
providing navigation toward a reported component with a mobile electronic device via a hierarchy of navigational functionality that includes a differential wireless signal positioning system and a short range beacon detection system;
verifying an identity of the reported component with the mobile electronic device;
providing a testing protocol with the mobile electronic device to diagnose a fault associated with the reported component;
providing a number of remedial instructions regarding the reported component with the mobile electronic device; and
providing a remediation verification protocol with the mobile device to confirm whether the remediation was successful.

2. The method of claim 1, wherein the hierarchy of navigational functionality further comprises a global positioning system (GPS) and wherein providing navigation comprises providing coarse navigation toward the reported component via the GPS.

3. The method of claim 1, wherein providing navigation comprises:
providing intermediate navigation toward the reported component via the differential wireless signal positioning system, wherein the differential wireless signal positioning system complies with an 802.11x standard; and
providing fine navigation toward the reported component via the short range beacon detection system.

4. The method of claim 3, wherein the short range beacon detection system complies with a Bluetooth standard or Radio-frequency identification standard.

5. The method of claim 1, wherein the verifying the identity of the reported component comprises optically capturing an identifier associated with the reported component via a visual identification device.

6. The method of claim 1, wherein providing the remedial instructions comprise providing instructions to repair the reported component.

7. The method of claim 1, wherein providing the testing protocol comprises displaying the testing protocol in a human-readable format.

8. The method of claim 1, wherein providing the remediation verification protocol comprises:
receiving wirelessly the remediation verification protocol; and
displaying the remediation verification protocol in a human-readable format.

9. The method of claim 1, wherein providing the remediation verification protocol comprises:
transmitting an outcome of the remediation verification protocol to a database.

10. A non-transitory machine readable medium storing a set of instructions executable by a processor to cause a computer to:
provide hierarchical navigation toward a reported component in a datacenter via a hierarchy of navigational functionality that includes a global positioning system, differential wireless signal positioning system, and a short range beacon detection system;
verify an identity of the reported component substantially at the location of the reported component with the mobile electronic device;
provide a test protocol to diagnose a fault associated with the reported component;
transmit results of the test protocol to a database coupled to the computer;
receive a number of remedial instructions from the database based on the results of the test protocol; and
provide a number of remedial instructions regarding remediation of the reported component.

11. The medium of claim 10, wherein provide a number of remedial instructions comprises:
receive wirelessly the number of remedial instructions; and
display the number of remedial instructions in a human-readable format.

12. A mobile electronic device for hierarchical navigation and remediation confirmation in datacenters, the device comprising:
a navigate module to provide navigation toward a location of a reported component via a hierarchy of navigational functionality that includes a global positioning system (GPS), differential wireless signal positioning system, and a short range beacon detection system;
a verify module to verify an identity of the reported component by optically capturing an identifier associated with the reported component via a visual identification device including a quick response code reader or a barcode reader;
a testing protocol module to receive a testing protocol to diagnose a fault associated with the reported component and transmit results of the testing protocol;
a remedial instructions module to receive a number of remedial instructions and provide the number of remedial instructions regarding remediation of the reported component with the mobile electronic device; and
a remediation verification module to receive a verification protocol to confirm whether the remediation was successful;
a wireless link module to wirelessly transmit data relating to the testing protocol module, the remedial instructions module, and the remediation verification module.

13. The device of claim 12, wherein the data comprises a result of the testing protocol and an outcome of the verification protocol.

14. The device of claim 13, wherein the provide navigation comprises
providing coarse navigation toward the reported component via the GPS;
providing intermediate navigation toward the reported component via the differential wireless signal positioning system, wherein the differential wireless signal positioning system complies with an 802.11x standard; and
providing fine navigation toward the reported component via the short range beacon detection system, wherein the short range beacon detection system complies with a Bluetooth standard or Radio-frequency identification standard.

15. The device of claim 13, wherein provide the remediation verification protocol comprises:
transmit the confirmation whether the remediation was successful comprises an output comprising yes or no and receive a set of instructions to reinitiate the testing protocol when the output is no.
